(19) United States
(12) Patent Application Publication
(10) Pub. No.: US 2004/0247245 A1
(43) Pub. Date: Dec. 9, 2004

(54) Bidirectional optical communication module with a reflector

(76) Inventors: Kyoung-Youm Kim, Anyang-shi (KR); Oh-Dal Kwon, Suwon-shi (KR); Joo-Hoon Lee, Yongin-shi (KR)

Correspondence Address: CHA & REITER, LLC, 210 ROUTE 4 EAST STE 103, PARAMUS, NJ, 07652, US

(21) Appl. No.: 10/692,347

(22) Filed: Oct. 23, 2003

(30) Foreign Application Priority Data
Jun. 5, 2003 (KR) 2003-36189

(51) Int. Cl. G02B 6/26

(52) U.S. Cl. 385/47; 385/39

(57) ABSTRACT

A bidirectional optical communication module capable of precisely controls the location of a reflective surface of the reflector is disclosed. The module includes: an input waveguide for inputting an optical signal; a reflector including a reflective groove formed by a photolithography process such that the groove is extended from one end surface of the bidirectional optical communication module to a connection waveguide, and a reflective layer formed on a base surface formed in the reflective groove so as to reflect the optical signal inputted from the input waveguide; and an output waveguide for outputting the optical signal reflected by the reflector. The connection waveguide is configured to transmit the optical signal inputted from the input waveguide to the reflector and output the optical signal reflected by the reflector to the output waveguide.

### CLAIM OF PRIORITY

This application claims priority to an application entitled “BIDIRECTIONAL OPTICAL COMMUNICATION MODULE WITH A REFLECTOR,” filed in the Korean Intellectual Property Office on Jun. 5, 2003 and assigned Serial No. 2003-36189, the contents of which are hereby incorporated by reference.

### BACKGROUND OF THE INVENTION

1. Field of the Invention

The present invention relates to a bidirectional optical communication module, and more particularly to a bidirectional optical communication module having a reflector for used in an optical communication network.

2. Description of the Related Art

Bidirectional optical communication modules are used to multiplex or demultiplex an optical signal in an optical communication network. A bidirectional optical communication module is typically manufactured by sequentially stacking an under cladding layer, a core layer formed having a designated pattern, and an over cladding layer on a silicon or polymer substrate.

In general, a light source for generating an optical signal and an optical detector for detecting a received optical signal are located at the transmitting and receiving terminals of the optical communication network. A bidirectional optical communication module is provided with both the light source and the optical detector installed on a single substrate, and transmits or receives an optical signal via a multiplexer. In order to minimize a cross-talk occurring between the light source and the optical detector, the light source and the optical detector are located apart at the respective terminal of the bidirectional communication module, wherein one of them is connected to the multiplexer via a reflector.

FIG. 1 is a schematic view of a reflector provided in a conventional bidirectional optical communication module. FIG. 2 is a schematic view another conventional reflector of a bidirectional optical communication module. The reflector 104 is manufactured by depositing or attaching a metal layer 141 at one end surface of the bidirectional optical communication module and serves to input an optical signal outputted from a multiplexer to a optical detector, or an optical signal generated by the light source to the multiplexer. As such, the function of the reflector 104 is determined according the position of the light source and the optical detector.

The reflector 104 shown in FIG. 1 is configured so that the metal layer 141 is connected to one terminal of a connection waveguide 143a, and an input waveguide 134 and an output waveguide 133 are connected to the other terminal of the connection waveguide 143a. An angle (θ_{b}) between the input waveguide 134 and the output waveguide 133 is relatively large in the range of 10° to 40°. The input waveguide 134 and the output waveguide 133 are connected to each other near the metal layer 141 of the reflector 104.

In the reflector 104 shown in FIG. 2, the angle (θ_{b}) between the input waveguide 134 and the output waveguide 133 is relatively small in the range of 2° to 5°, and the input waveguide 134 and the output waveguide 133 are connected substantially to each other at one end of the connection waveguide 143b.

The bidirectional optical communication module provided with the above reflector 104 is manufactured by obtaining a multiplexer, a waveguide, etc. More particularly, the module is provided via the steps of depositing a core layer and an under cladding layer on a silicon or polymer substrate, etching the core layer via a photolithography process, and depositing an over cladding layer thereon. Thereafter, the reflector 104 is obtained via the steps of dicing the substrate into sections 117, polishing the resulting section 117, and depositing the metal layer 141 on the section 117 of the substrate. Note that those skilled in the art will easily understand the above method.

However, the bidirectional optical communication module obtained through dicing a substrate into sections, polishing the section of the substrate, and depositing the metal layer on the section, cannot reduce location deviation occurring within ±10 μm in the manufacturing process due to the characteristics in the dicing and polishing steps. As a result, the location of a reflective surface, i.e., the length of the connection waveguide, can be deviated different from a designed or desired value. This means that during the passing of an optical signal through the reflector, the traveling length of an optical signal in the reflector can be changed from a designed value by up to ±20 μm. This causes several problems, such as a reduction in the reflectivity of the reflector and an increase in the optical signal loss passing through the reflector.

### SUMMARY OF THE INVENTION

Therefore, the present invention has been made to overcome the above problems and provides additional advantages, by providing a bidirectional optical communication module provided with a reflector which improves the precision in the location of a reflective surface, thus enhancing the reflectivity and decreasing the optical loss of the reflector.

In accordance with one aspect of the present invention, a bidirectional optical communication module is provided and includes: an input waveguide for inputting an optical signal; a reflector including a reflective groove formed by a photolithography process such that the groove is extended from one end surface of the bidirectional optical communication module to a connection waveguide; and a reflective layer formed on a base surface formed in the reflective groove so as to reflect the optical signal inputted from the input waveguide; an output waveguide for outputting the optical signal reflected by the reflector; and a connection waveguide for transmitting the optical signal inputted from the input waveguide to the reflector and outputting the optical signal reflected by the reflector to the output waveguide.

In accordance with another aspect of the present invention, a bidirectional optical communication module includes: a multiplexer connected to a first waveguide for outputting or inputting a multiplexed optical signal and two or more second waveguides for inputting or outputting a demultiplexed optical signal; a reflective layer, connected to a terminal of one selected from the second waveguides, for reflecting the optical signal; and a third waveguide for inputting the optical signal to the reflective layer or outputting the optical signal reflected by the reflective layer, wherein the reflective layer is formed on a base surface formed in a reflective groove formed by a photolithography process such that the groove is extended from one end surface of the bidirectional optical communication module.

### BRIEF DESCRIPTION OF THE DRAWINGS

The above features and other advantages of the present invention will be more clearly understood from the following detailed description taken in conjunction with the accompanying drawings, in which:

FIG. 1 is a schematic view of a reflector of one conventional bidirectional optical communication module;

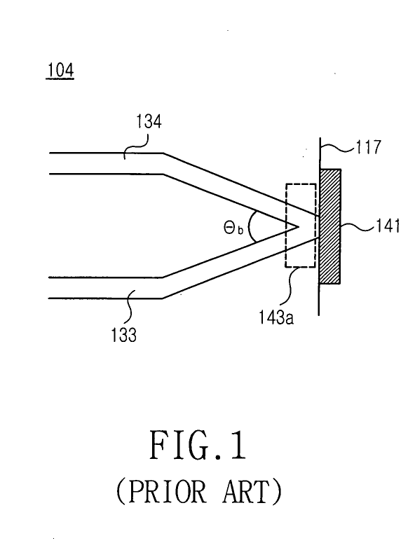

FIG. 2 is a schematic view of a reflector of another conventional bidirectional optical communication module;

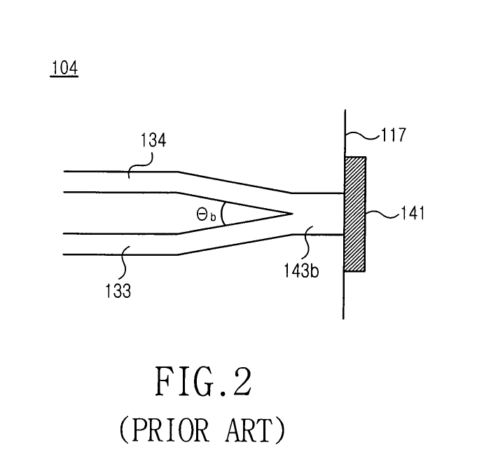

FIG. 3 is a schematic view of a bidirectional optical communication module provided with a reflector in accordance with one preferred embodiment of the present invention;

FIG. 4 is a schematic view of a bidirectional optical communication module provided with the reflector of FIG. 3 in accordance with another preferred embodiment of the present invention;

FIG. 5 is an enlarged view of the reflector of the bidirectional optical communication module shown in FIG. 3;

FIG. 6 is a plan view of the reflector of the bidirectional optical communication module shown in FIG. 5;

FIG. 7 is a plan view of another example of the reflector of the directional optical communication module shown in FIG. 5;

FIG. 8 is a graph illustrating the variation of reflectivity according to the variation of the linewidth of an optical waveguide;

FIG. 9 is a graph illustrating the variation of reflectivity according to the variation of the location of the reflector shown in FIG. 6; and

FIG. 10 is a graph illustrating the variation of reflectivity according to the variation of the location of the reflector shown in FIG. 7.

### DETAILED DESCRIPTION OF THE PREFERRED EMBODIMENTS

Now, preferred embodiments of the present invention will be described in detail with reference to the annexed drawings. For the purposes of clarity and simplicity, a detailed description of known functions and configurations incorporated herein will be omitted as it may make the subject matter of the present invention unclear.

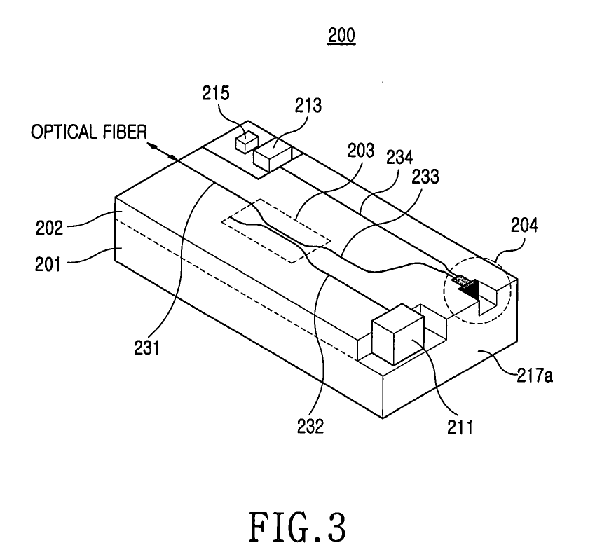

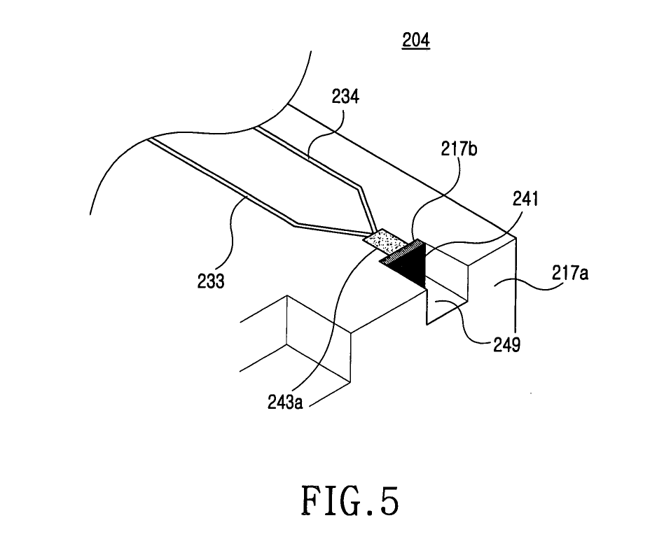

FIG. 3 is a schematic view of a bidirectional optical communication module 200 having a reflector in accordance with one preferred embodiment of the present invention. As shown, the bidirectional optical communication module 200 includes a multiplexer 203, a reflective groove (249 shown in FIG. 5), and optical waveguides 231, 232, 233 and 234. The multiplexer 203, the reflective groove 249, and the optical waveguides 231, 232. 233 and 234 are formed by stacking an under cladding layer 202 on a silicon or polymer substrate 201, stacking a core layer (not shown) on the under cladding layer 202, etching the core layer using a photolithography process, and then depositing an over cladding layer (not shown) thereon. The bidirectional optical communication module 200 further comprises a light source 213 and an optical detector 211 installed at a pre-designated location thereof. The multiplexer 203, the reflector 204, the light source 213, and the optical detector 211 are connected to one another via the waveguides 231, 232, 233 and 234. The reflector 204 includes a metal layer ( 241 shown in FIG. 5) formed in the reflective groove 249 extended from one end surface 217a of the bidirectional optical communication module 200. Preferably, the reflective groove 249 is obtained by etching, using the photolithography process, so as to assure the precision in the location of the reflector 204.

The multiplexer 203 may be one selected from the group consisting of a directional coupler, a multi mode interferometer, or an arrayed waveguide grating. In FIG. 3, a directional coupler is used as the multiplexer 203. The multiplexer 203 outputs an optical signal received from an optical fiber of a communication network to the optical detector 211, and outputs an optical signal oscillated by the light source 213 to the optical fiber of the communication network.

FIG. 5 is an enlarged view of the reflector 204 of the bidirectional optical communication module 200 shown in FIG. 3. As shown, the reflector 204 is obtained by depositing or attaching the metal layer 241 in the reflective groove 249 formed at one end surface of the bidirectional optical communication module 200.

The reflective groove 249 is formed by the photolithography process and extended from one end surface of the bidirectional optical communication module 200 in a longitudinal direction. The reflector 204 is completed by depositing or attaching the metal layer 241 on a base surface 217b where the reflective groove 249 and a connection waveguide 243a of the bidirectional optical communication module 200 are connected. Accordingly, the base surface 217b of the reflective groove 204 is used as a reflective surface of the reflector 204. Since the reflective groove 249 is obtained using the photolithography process, it is possible to assure a precise location of the reflector 204 in the module, more specifically the location of the base surface 217b. With the conventional dicing and polishing procedures, it was difficult to control the location of the reflector in the range of ±10 μm from a designed value. However, with the photolithography process, it is possible to control the location of the reflector 204 up to the range of ±0.2 μn from the designed value.

The waveguides 231, 232, 233 and 234 consist of a first waveguide 231, at least two second waveguides 232 and 233, and a third waveguide 234. The first waveguide 231 forms an optical signal transmission line between an optical fiber of an optical communication network and the multiplexer 203. Each of the second waveguides 232 and 233 outputs an optical signal from the multiplexer 203 to the optical detector 211, or inputs an optical signal generated by the light source 213 to the multiplexer 203. The third waveguide 234 forms an optical signal transmission line between the reflector 204 and the light source 213. The reflector 204 reflects the optical signal generated by the light source 213 in the direction of the multiplexer 203. Viewed from the reflector 204, the third waveguide 234 serves as an input waveguide for inputting the optical signal generated by the light source 213 to the reflector 204, and one waveguide selected from the second waveguides 232 and 233 serves as an output waveguide for outputting the reflected optical signal to the multiplexer 203.

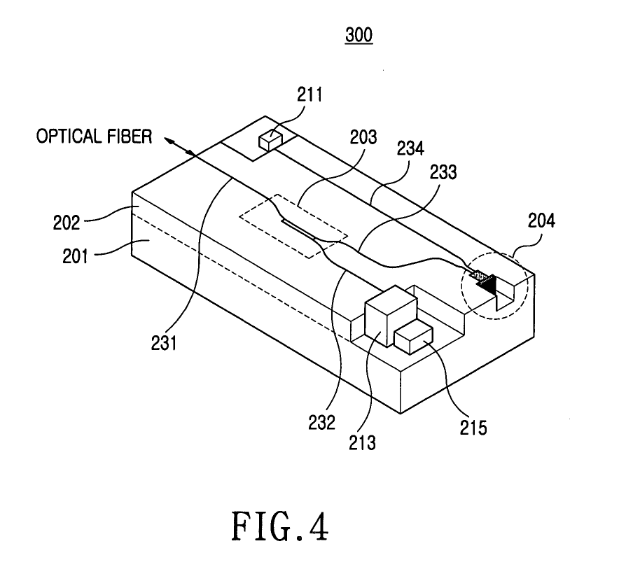

In FIG. 4, which shows another embodiment, a multimode interferometer is used as the multiplexer 203. The reflector 204 is connected to the optical detector 211 via the third waveguide 234. That is, the reflector 204 reflects an optical signal outputted from the multiplexer 203, and then inputs the reflected optical signal to the optical detector 211. Accordingly, the reflector 204 shown in FIG. 4 receives an optical signal via the second waveguide 233, and then outputs the received optical signal to the optical detector 211 via the third waveguide 234.

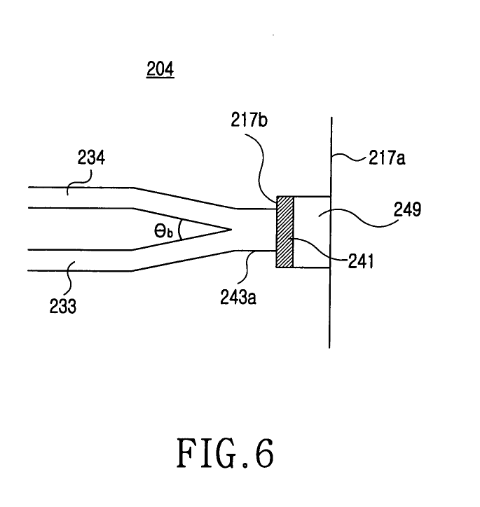

FIG. 6 is a plan view of the reflector 204 of the bidirectional optical communication module 200 shown in FIG. 5. The reflector 204 is connected to the second waveguide 233 and the third waveguide 234 via a connection waveguide 243a. In the reflector 204 shown in FIG. 6, an angle (θ_{b}) between the second waveguide 233 and the third waveguide 234 is in the range of 2° to 5°, and the second waveguide 233 and the third waveguide 234 are connected to the reflector 204 via the connection waveguide 243a.

The reflectivity (R) of the reflector 204 shown in FIG. 6 is defined by the below equation 1 according to the location of the base surface, i.e., the reflective surface 217b.

$$R = {R}_{0} {cos}^{2} [ \frac{2 π ( {n}_{0} - {n}_{1} )}{λ} d ] \qquad \text{[Equation 1]}$$

Here, R₀ denotes the reflectivity of the reflector having a designed location value, and n₀ and n₁ respectively denote the effective refractive indices of first and second modes at the connected area of the second and third waveguides, i.e., the connection waveguide 243a. λ denotes the wavelength of an optical signal, and d denotes the variation in the location of the base surface 217b. That is, d represents the difference between the designed location value and an actual location value of the reflector.

The allowance value (d₀) of the difference (d) of the location of the reflective surface 217b is determined by the allowance limit of the loss of the reflector 204. That is, if an additional loss of the reflector 204 according to the difference (d) of the location of the reflective surface 217b is allowable up to x dB, the allowance value (d₀) of the difference (d) of the location of the reflective surface 217b is defined by the below equation 2.

$${d}_{0} = \frac{λ}{4 π ( {n}_{0} - {n}_{1} )} {cos}^{- 1} ( 2 \times {10}^{- x / 10} - 1 ) \qquad \text{[Equation 2]}$$

Here, in case that the second waveguide 233 and the third waveguide 234 are connected such that the angle (θ_{b}) between the second waveguide 233 and the third waveguide 234 is in the range of 2° to 5°, the refractive indices (n₀, n₁) of the first and second modes are affected by the linewidth of the wavelength.

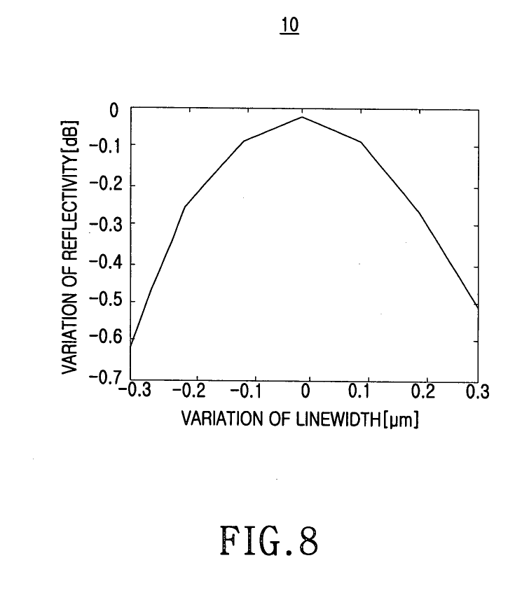

FIG. 8 shows a graph 10 illustrating the variation of reflectivity according to the variation of the linewidth of the waveguide under the condition that the location of the reflective surface 217b is fixed. Generally, the linewidth of the waveguide manufactured using the photolithography process has a variation of ±0.2 μm from a designated value. As shown in FIG. 8, when the linewidth of the waveguide has a variation of ±0.2 μm, the reflectivity (R) is reduced by approximately 0.2 dB. It is appreciated by those skilled in the art that the location of the base surface, i.e., the reflective surface 217b, is more precisely controlled according to the reduction of the reflectivity (R) due to the variation of the linewidth of the optical waveguide.

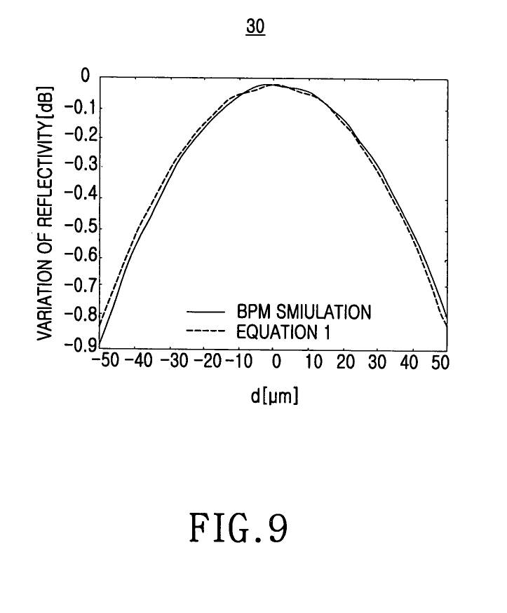

FIG. 9 comparatively illustrates the variation of the value of reflectivity (R) calculated by the Equation 1 according to the difference (d) of the reflective surface 217b, and the variation of the value of reflectivity (R) obtained by a BPM (beam propagation method) simulation. Here, the waveguide has a width of 6.5 μm and a height of 6.5 μm, and the refractive index difference between a core and a cladding layer of the waveguide is 0.75%. Depending on the calculated results, under the condition that the loss of reflectivity is 0.2 dB according to the variation of the linewidth of the waveguide, the allowance value (d₀) of the difference (d) of the location of the reflective surface 217b must be limited to be in the range of 5.7 μm to 12.6 μm in order to control the additional loss (x) of the reflector 204 within the range of 0.05 dB to 0.01 dB. Since it is difficult to control the variation of the location of the reflective surface 217b within the range of ±10 μm during the conventional dicing and polishing process, the above allowance value (d₀) of the difference (d) of the location of the reflective surface 217b cannot be obtained by the conventional dicing and polishing procedures. This allowance value (d₀) of the difference (d) of the location of the reflective surface 217b is obtained by the photolithography process, in which the difference (d) of the location of the reflective surface 217b is controlled up to the range of ±0.2 μm.

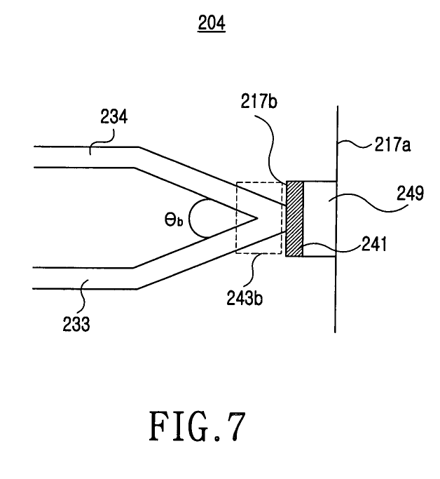

Referring to FIG. 7, an angle (θ_{b}) between the second waveguide 233 and the third waveguide 234 is in the range of 10° to 40° in the reflector 204, and the second waveguide 233 and the third waveguide 234 are connected at one of their terminals, thus forming a single connection waveguide 243b.

The reflectivity (R) of the reflector 204 shown in FIG. 7 is determined by the location of the base surface, i.e., the reflective surface 217b, and defined by the below equation 3.

$$R = {R}_{0} exp [ - \frac{{d}^{2} {sin}^{2} {θ}_{b}}{{w}^{2} {cos}^{2} ( {θ}_{b} / 2 )} ] \qquad \text{[Equation 3]}$$

Here, R₀ denotes the reflectivity of the reflector with a designed location value, and d denotes the variation in the location of the base surface 217b. That is, d represents the difference between the designed location value and an actual location value of the reflector 204. θ_{b} denotes an angle between the second waveguide 233 and the third waveguide 234, and w denotes the half value of a MFD (mode field diameter) of the optical waveguide.

If an additional loss of the reflector 204 according to the difference (d) of the location of the reflective surface 217b is allowable up to x dB, the allowance value (d₀) of the difference (d) of the location of the reflective surface 217b is defined by the below equation 4.

$${d}_{1} = \sqrt{\frac{x {w}^{2} {cos}^{2} ( {θ}_{b} / 2 )}{10 {log}_{10} e {sin}^{2} {θ}_{b}}} \qquad \text{[Equation 4]}$$

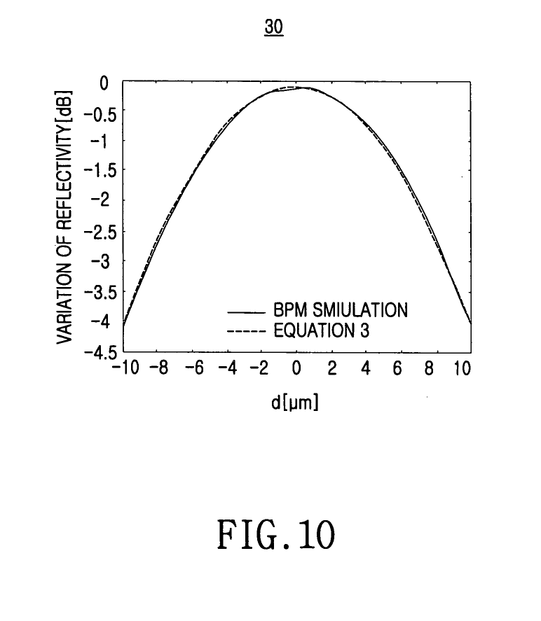

FIG. 10 comparatively illustrates the variation of the value of reflectivity (R) of the reflector 204 calculated by the Equation 3 according to the difference (d) of the reflective surface 217b, and the variation of the value of reflectivity (R) obtained by the BPM (beam propagation method) simulation. In case that the waveguide has a width of 6.5 μm and a height of 6.5 μm, the refractive index difference between a core and a cladding layer of the waveguide is 0.75%, and the angle (θ_{b}) between the second waveguide 233 and the third waveguide 234 is 20°, the difference (d) of the location of the reflective surface 217b must be limited to be within the range of 1.6 μm in order to control the additional loss (x) of the reflector 204 within the range of 0.1 dB. Accordingly, it is preferable to manufacture the reflector 204 using the photolithography process in which the difference (d) of the location of the reflective surface 217b can be limited to ±0.2 μm.

As apparent from the above description, the present invention provides a bidirectional optical communication module provided with a reflector, in which the location of a reflective surface is determined by a photolithography process and the reflector is obtained by depositing a metal layer on a substrate, thus precisely controlling the location of the reflective surface of the reflector. Accordingly, it is possible to prevent the reflectivity of the reflector from being lowered due to the variation of the location of the reflective surface, thereby reducing the defective portion of final products of the modules improving the productivity in a module manufacturing process, and reducing the production cost of the module.

Although embodiments of the present invention have been described in detail, those skilled in the art will appreciate that various modifications, additions, and substitutions to the specific elements are possible, without departing from the scope and spirit of the invention as disclosed in the accompanying claims.

What is claimed is:

1. A bidirectional optical communication module comprising:
an input waveguide for inputting an optical signal;
a reflector having a reflective groove formed by a photolithography process, the reflective groove extending from one end surface of the bidirectional optical communication module to a connection waveguide,
a reflective layer formed on a base surface of the reflective groove, to reflect the optical signal inputted from the input waveguide; and
an output waveguide for outputting the optical signal reflected by the reflector,
wherein the connection waveguide is configured to transmit the optical signal inputted from the input waveguide to the reflector and output the optical signal reflected by the reflector to the output waveguide.

2. The bidirectional optical communication module as set forth in claim 1,
wherein the input waveguide and the output waveguide coupled to the connection waveguide are overlapped so that an angle between the input waveguide and the output waveguide is in the range of 2° to 5°.

3. The bidirectional optical communication module as set forth in claim 2,
wherein a variation of the location of the base surface is limited in the range of an allowance value defined by the following equation:
$${d}_{0} = \frac{λ}{4 π ( {n}_{0} - {n}_{1} )} {cos}^{- 1} ( 2 \times {10}^{- x / 10} - 1 ) ,$$
wherein d₀ represents the allowance value of the variation of the location of the base surface, λ represents the wavelength of the optical signal, n₀, n₁ represent the effective refractive indices of first and second modes at the connection waveguide where the input and output waveguides are connected, and x represents the loss value for determining an area on which an additional loss is generated.

4. The bidirectional optical communication module as set forth in claim 1,
wherein the input waveguide and the output waveguide coupled to the connection waveguides are overlapped so that an angle between the input waveguide and the output waveguide is in the range of 10° to 40°.

5. The bidirectional optical communication module as set forth in claim 4,
wherein the variation of the location of the base surface is limited in the range of an allowance value defined by the following equation:
$${d}_{1} = \sqrt{\frac{x {w}^{2} {cos}^{2} ( {θ}_{b} / 2 )}{10 {log}_{10} e {sin}^{2} {θ}_{b}}} ,$$
wherein d₀ represents the allowance value of the variation of the location of the base surface, x represents the loss value for determining an area on which an additional loss is generated, w represents the half value of a MFD (mode field diameter) of the optical waveguide, and θ_{b} represents the angle between the input waveguide and the output waveguide.

6. The bidirectional optical communication module as set forth in claim 1,
wherein the reflective layer is a metal layer deposited or attached on the base surface formed in the reflective groove.

7. The bidirectional optical communication module as set forth in claim 1, further comprising a multiplexer formed thereon, wherein the input waveguide is coupled to the multiplexer, and the output waveguide is coupled to an optical detector.

8. The bidirectional optical communication module as set forth in claim 1, further comprising a multiplexer formed thereon, wherein the input waveguide is coupled to a light source, and the output waveguide is coupled to the multiplexer,

9. The bidirectional optical communication module as set forth in claim 1, further comprising:
a multiplexer;
a substrate made of silicon or polymer; and
a cladding layer stacked on the substrate,
wherein the multiplexer, the input waveguide, the output waveguide, the connection waveguide, and the reflective groove are formed on the cladding layer.

10. The bidirectional optical communication module as set forth in claim 9, wherein the multiplexer is one of a directional coupler, a multi mode interferometer, and an arrayed waveguide grating.

11. A bidirectional optical communication module, comprising:
a multiplexer connected to a first waveguide for outputting or inputting a multiplexed optical signal and two or more second waveguides for inputting or outputting a demultiplexed optical signal;
a reflective layer, connected to a terminal of one waveguide selected from the second waveguides, for reflecting the optical signal; and
a third waveguide for inputting the optical signal to the reflective layer or outputting the optical signal reflected by the reflective layer,
wherein the reflective layer is formed on a base surface formed in a reflective groove formed by a photolithography process such that the groove is extended from one end surface of the bidirectional optical communication module.

12. The bidirectional optical communication module as set forth in claim 1 1, further comprising:
a light source formed on a terminal of another waveguide selected from the second waveguides; and
an optical detector formed on a terminal of the third waveguide.

13. The bidirectional optical communication module as set forth in claim 1 1, further comprising:
an optical detector formed on a terminal of another waveguide selected from the second waveguides; and
a light source formed on a terminal of the third waveguide.

14. The bidirectional optical communication module as set forth in claim 1 1, further comprising a connection waveguide for inputting the optical signal to the reflective layer or outputting the optical signal reflected by the reflector,
wherein the one waveguide selected from the second waveguides and the third waveguide are overlapped at a predetermined angle at a terminal of the connection waveguide.

15. The bidirectional optical communication module as set forth in claim 14,
wherein the input waveguide and the output waveguide coupled to the connection waveguide are overlapped such that an angle between the input waveguide and the output waveguide is in the range of 2° to 5°.

16. The bidirectional optical communication module as set forth in claim 15,
wherein the variation of the location of the base surface is limited in the range of an allowance value defined by the following equation:
$${d}_{0} = \frac{λ}{4 π ( {n}_{0} - {n}_{1} )} {cos}^{- 1} ( 2 \times {10}^{- x / 10} - 1 ) ,$$
wherein d₀ represents the allowance value of the variation of the location of the base surface, λ represents the wavelength of the optical signal, n₀, n₁ represents the effective refractive indices of first and second modes at the connection waveguide where the second and third waveguides are connected, and x represents the loss value for determining an area on which an additional loss is generated.

17. The bidirectional optical communication module as set forth in claim 14,
wherein the input waveguide and the output waveguide coupled to the connection waveguide are overlapped such that an angle between the input waveguide and the output waveguide is in the range of 10° to 40°.

18. The bidirectional optical communication module as set forth in claim 17,
wherein the variation of the location of the base surface is limited in the range of an allowance value defined by the following equation:
$${d}_{1} = \sqrt{\frac{x {w}^{2} {cos}^{2} ( {θ}_{b} / 2 )}{10 {log}_{e} {sin}^{2} {θ}_{b}}} ,$$
d₀ represents the allowance value of the variation of the location of the base surface, x represents the loss value for determining an area on which an additional loss is generated, w represents the half value of a MFD (mode field diameter) of the optical waveguide, and θ_{b} represents the angle between the input waveguide and the output waveguide.

19. The bidirectional optical communication module as set forth in claim 11, wherein the multiplexer is one of a directional coupler, a multi mode interferometer, and an arrayed waveguide grating.
